(19) United States
(12) Patent Application Publication
(10) Pub. No.: US 2004/0251451 A1
(43) Pub. Date: Dec. 16, 2004

(54) Lacquer layer, which reflects infra-red radiation

(76) Inventors: Detlef Burgard, Volklingen (DE); Rudiger Nass, Riegelsberg (DE)

Correspondence Address: John F Hoffman, Baker & Daniels, Suite 800, 111 East Wayne Street, Fort Wayne, IN, 46802, US

(21) Appl. No.: 10/499,734

(22) PCT Filed: Dec. 9, 2002
(86) PCT No.: PCT/DE02/04490

(30) Foreign Application Priority Data
Dec. 8, 2001 (DE) 10160356.8

(51) Int. Cl. C08K 3/18

(52) U.S. Cl. 252/520.1; 524/430

(57) ABSTRACT

The invention relates to a method for producing a transparent IR shield. According to said method, a carrier is provided with an active substance and is placed in the radiation path. To achieve this, a lacquer system comprising nanoparticulate particles and solvents that are conventionally contained in lacquers are applied to a substrate in a wet process.

### DESCRIPTION

The invention concerns the object of the preamble claim and therefore also concerns layers that shield infra-red radiation.

The shielding of infra-red radiation is becoming more important in various areas. In architectural work, such as with large glass surfaces in sky-scrapers, there is often a requirement for keeping the infra-red rays to a minimum in the building, so as to hold the temperature down in building interiors in southern countries but to also let in the maximum amount of daylight possible. The same applies in the automobile glass industry, where improvements in aerodynamics, while retaining the same visibility, make larger areas of glass necessary. Heating the interior is not desired here either. If the radiating warmth is not shielded sufficiently, many users will resort to acclimatization using air-conditioning, in houses and in cars. The heat-radiation then causes increased power consumption.

There can also be requirements for other radiated heat behaviors in other situations; especially in northern countries, for greenhouses, etc. In this case, the radiated heat should be kept in the building but none should be allowed to escape. This also applies in a similar manner for certain types of sheeting material such as for hot-houses, tent material, clothing, etc. In these cases, the opposite effect can be desired, whereas too much warmth should be avoided by radiating the inner heat outward and if possible to prevent any heat entering at the same time. It is explicitly stated that this respective behavior is only desired in certain cases and is therefore not always strived for. There can also be cases in which the heat-flow is to be suppressed completely, i.e. neither exchanging from inside to outside nor from outside to inside. As an example, an automobile has been mentioned for which the interior is to be protected from the sun in summer and the available heat from the heater should remain to as great an extent as possible inside to provide quickly warming up but also to avoid cooling off when at a standstill.

Laminated glass has been suggested (EP 0 727 306 A2), in which an intermediate film is provided between the first and second transparent glass plates, in which ultra-fine functional particles are dispersed with a particle diameter of up to 0.2 μm. This film should consist of plasticized PVB (polyvinyl butyral) or of ethylene-vinyl acetate-copolymer (EVA). As functional particles, the suggestion in EP 0 727 306 A2 was the compounds and composites that contain metal from the group consisting of metals. The metals should consist of Sn, Ti, Si, Zn, Zr, Fe, Al, Cr, Co, Ce, In, Ni, Ag, Cu, Pt, Nn, Ta, W, V and Mo. It stated as metal compounds oxide, nitride, oxinitride and sulfide; the composites should be doped with at least one substance and the compound should be doped with at least one substance. As an Oxide, SnO₂, TiO₂, SiO₂, ZrO₂, ZnO₂, Fe₂O₃, Al₂O₃, FeO, Cr₂O₃, Co₂O₃, CeO₂, In₂O₃, NiO, MnO and CuO were named. There are discussions on the amounts of substance to be integrated into the original resin and discussions indicating that the film can only have a maximum conductivity in order to achieve satisfactory radio-wave permeability.

The previous processes have led to suitable results in special applications but not completely satisfactory in all cases. This applies in particular when good IR shielding layers are desired with improved conductivity in order to retain anti-static properties or to provide dissipating layers. There are also difficulties in manufacturing infra-red shielding, complex objects such as very curved windshields, etc.

Another procedure which is well-known as a technological standard is the gas-phase coating on flat-glass which can be caused by sputtering, CVD, PVD, etc. As film materials, ultra-thin layers of conductive or semi-conductive doped oxides can be applied by sputtering, for example of ATO (SnO₂:Sb) FTO (SnO₂:F) AZO (ZnO:Al) or ITO (In₂O₃:Sn). When these layers are applied ultra-thin, they are transparent for visible light and decrease the transmission of infra-red radiation. Conductive layers can be used as continuous layers. The devices used for spreading these types of thick layers are very expensive however, which means that it is only worth while with large quantities or layering with larger amounts of material. Much more target material is also required than is separated on the substrate. The remainder is stuck in the machine from which it must typically be removed, which is, not only because of the poor utilization of the expensive target, extremely undesirable.

Although this type of sputter machine is technically very complicated, it is extremely difficult to use it for spreading layers on complex formed objects in small or special orders, since every change in geometry requires considerable reconstruction of major parts in the system. Attempts that have been made to sputter automobile windshields as flat pieces and to then bend them into the desired aerodynamic forms have long since been aborted. Spreading layers of polymers or sheeting, as is quite often the wish, is only possible conditionally.

The goal of the invention is to introduce new technology into the commercial application.

The goal will be achieved with the characteristics of the independent claim. Favored versions can be found in the claims below.

Therefore, the invention suggests, based on a first aspect, a procedure for manufacturing a transparent IR shielding whereby a carrier is applied with an active ingredient, in order to be placed in the radiation path, which has been already prepared by spreading nanoparticulate particles and conventional lacquer solvent with a lacquer system that can apply a film without nanoparticulate particles, onto a substrate in a wet process.

Surprisingly, it was recognized that the nanoparticulate particles produced a good infra-red shielding effect even if prepared for integration in a lacquer system to be integrated into. This effect is used to enable the lacquer system to be applied with the nanoparticulate particles in a wet process. The advantage is that on one hand, there are less technological requirements for the application itself which opens up a multitude of new application possibilities and even if no large amounts are to be produced and on the other hand, even complex geometrical forms can be handled. More materials, especially polymer and/or sheeting can be handled that are possible with the latest technology.

Preferably, the nanoparticulate particles are dispersed in the lacquer system. The nanoparticulate particles that were used in lacquer system manufacture can be prepared for the simple dispersion or re-dispersion in the lacquer system for this. The methods used in achieving the desired re-dispersion are already known to a certain degree. It is important, however, that good IR shielding results from the application of the known methods.

It is possible to achieve the infra-red shielding effect of the nanoparticulate particles for a multiple of conventional lacquer solvents which expands the application range, since the lacquer system can be optimized for certain substrates and/or application conditions such as application for an interior, exterior facades under different typical weather conditions like high humidity, heavy precipitation, etc., for aircraft, especially the cockpit glass, automobiles, etc. An especially temperature-resistant lacquer system can also be chosen if infra-red shielding is to be achieved in high-temperature applications where highly tempered spaces, such as an oven, should heat but not allow heat to escape.

It is possible to use a mixture of various conventional lacquer solvents, to achieve various optimized characteristics such as abrasive and strength characteristics, resistance against peeling and flaking, heat resistance, UV-resistance, etc.

The lacquer system can be used as a bonding agent, especially in the form of organic components. The organic components can be applied in monomer, oligomer or polymer form and can be processed to at least one of the polymer group polycrylate, in particular PMMA, polyvinyl pyrrolidone (PVP), polyvinyl butyral (PVB), polyvinyl alcohol (PVA), polyethylene glycole, polyurethane, bisphenol based polymer, polyester as well as oligomers and/or monomers previously mentioned polymers and/or cellulose derivate, in particular methyl cellulose, hydroxypropyl cellulose and/or nitrocellulose and/or metal-organic compounds. It is also possible to apply silicone and/or silane in monomer, oligomer and/or polymer form.

The nanoparticulate particles typically lie in a range between 1 and 200 nm. This, therefore, ensures that, on one hand, the production process can be handled well and on the other hand, the characteristics of the lacquer system are defined with adequate precision.

If the particles are smaller than 200 nm, it ensures that the transparency is not affected in the visible range whereby the high percentage of particle sizes at or under 100 nm results in good homogeneity with the increase in total particles. As nanoparticles, those mentioned in the EP 0 727 306 discussions come into consideration.

PMMA, in particular, and PVB and similar materials can be used as substrates in addition to the anorganic glasses, such as silicate glass which is typically used for flat glassicular PMMA. This enables the lacquer system in accordance with the invention to be used with polymers which is advantageous for creating light-weight glass, creating new application possibilities, etc. This way, drink bottles can be easily provided with infra-red shielding which is advantageous when the bottled drink should stay cold. The layer introduced here would ensure this.

This invention enables the application using a number of different techniques that can all be applied economically. While techniques such as immersion will result in a complete cover, a pattern can also be created on the object with a stamp, for example which is especially advantageous in combination with the improved conductivity. This way, conductive, transparent and at the same time IR shielded antenna regions can be integrated into automobile windshields for radio signal reception and/or for sending and receiving mobile radio signals. This can also be accomplished over a large surface.

If the application must be made over a very complicated form or individual patterns are to be stamped and which are not to be repeated from object to object, or are only identical for a small number of products such as with serial numbers, batch numbers, etc., application can be handled using an ink-jet process. Since the layer is invisible, it is possible to produce an invisible coding. In this case, areas within the layers on the surface of the coated object can be scanned for conductivity for integrating electrodes in predefined positions for example and/or scanning hidden information by irradiating infra-red radiation whereby either the heat will be registered on the substrate or the transmission behind the coated substrate. In this type of case, the coating can also be enclosed between two surfaces, for example, on the inside of thermal-glass, etc. The combination of predetermined conductivities and IR shielding enables especially secure authenticity verification.

Drying is typically gentle and is done at temperatures under 100° C. for example. Drying can be done at room temperature and alternatively at increased temperatures warming to 50° to 70° C. without losing any of the positive characteristics of the layers.

It is stated that it is particularly advantageous to achieve at least antistatic characteristics with the coating or with the layer's even further improved conductivity, feed through it or a totally conductive layer. This is particularly possible if nanoparticulate particles that are highly conductive are used. ITO, in particular ITO with comparably high conductivity as doped ITO, is highly favored. Note that the expensive ITO material is highly conductive with comparably low quantities and the targeted effect can evolve in particular under the percolation limits.

As mentioned to begin with, many applications require a type of heat-radiation case or diode-like behavior for heat-radiation, i.e. radiated heat only in one direction but not in the opposite direction. This invention suggests, in one particular variation, choosing an absorption constant so that the coating is transparent at the maximum solar energy radiation. This solar energy radiation is at its maximum within a range from 800 nm and 1100 nm. This range is especially relevant for heating therefore. The fact that the selection of the absorption edge position allows the radiation of thermal solar radiation to a high degree while the irradiation from the interior can be greatly decreased was recognized. This is because the heat radiation—not possible here—to be irradiated is typically longer waved than the radiated one. In an especially preferred version, the absorption edge therefore lies between the near infrared (NIR) of the radiation and the far infrared of the irradiation (FIR) which therefore reflects sooner and/or absorbed and then transmitted. Especially preferred is therefore the position of the absorption edge beyond, but close to 1100 nm, especially in the range between 1120 and 1350. With absorption edges within smaller wave lengths, more of the thermal solar radiation that is desired here is shielded. It was determined that the layers found are visibly completely or at least very close to completely transparent and irrespective of a yellow value of the base material.

In another version, preferred for another purpose, an ITO which has an absorption edge at approximately 1100 nm is to be used and then to integrate another absorber in the coating which absorbs within a range under 900 nm. Especially preferred is the use of a UV-resistant absorber. At the same time, an organic absorber should be used, which can be introduced into the popular lacquering systems with no problems. Phthalocyanine color has proven to be especially suitable and is visibly transparent as well as UV-resistant. An especially suitable absorber is called YKR 50/10 phtalocyanine color made by Yamamoto Chemicals. It was determined that only 10% of the color in reference to the ITO weight is sufficient to achieve a wide-banded absorbing layer.

The invention is described in diagrams to follow as an example only. The following is shown:

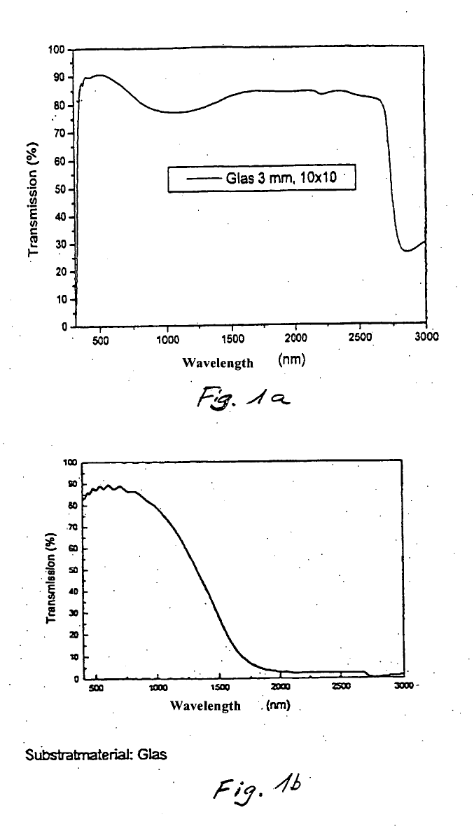

FIG. 1a the transmission through an uncoated glass substrate;

FIG. 1b the transmission through a coated glass substrate;

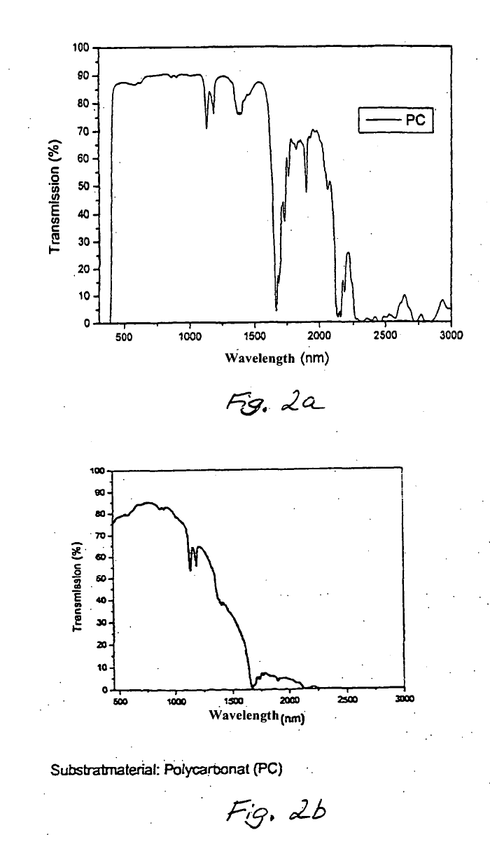

FIG. 2a the transmission through an uncoated PC substrate;

FIG. 2b the transmission through a coated PC (Polycarbonate) substrate;

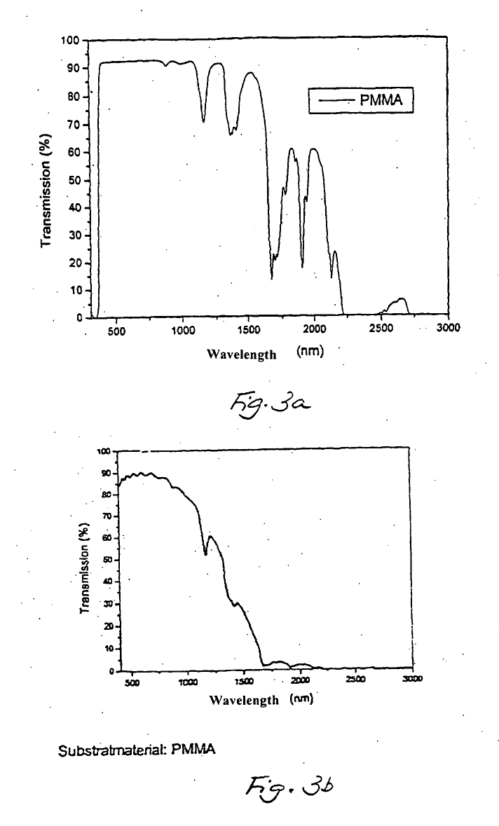

FIG. 3a as previous for an uncoated PMMA substrate;

FIG. 3b as previous for the coated PMMA substrate,

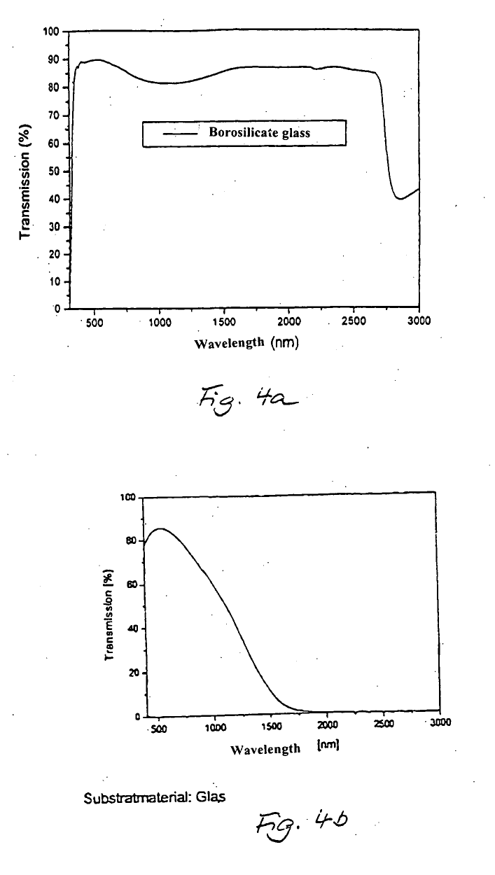

FIG. 4a as previous for an uncoated Borosilicate glass substrate;

FIG. 4b as previous for a coated Borosilicate glass substrate;

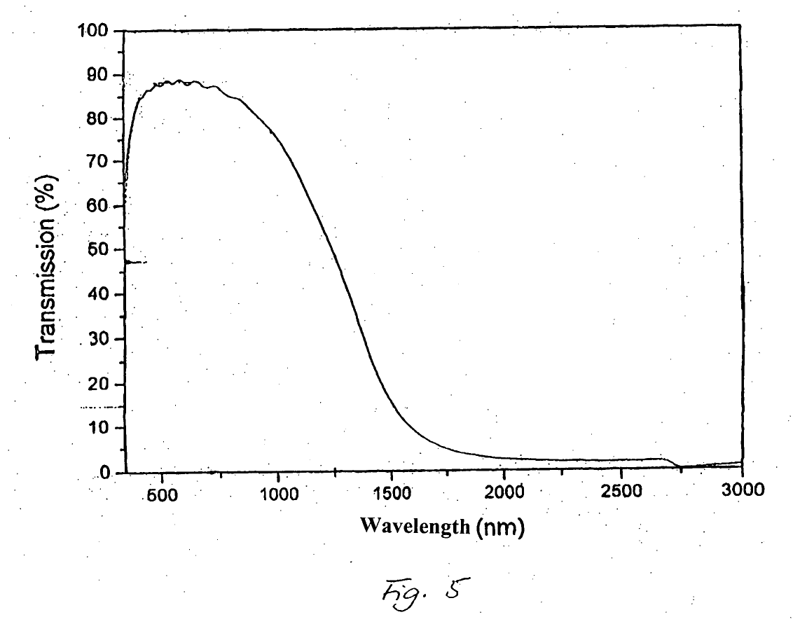

FIG. 5 as previous for Borosilicate glass;

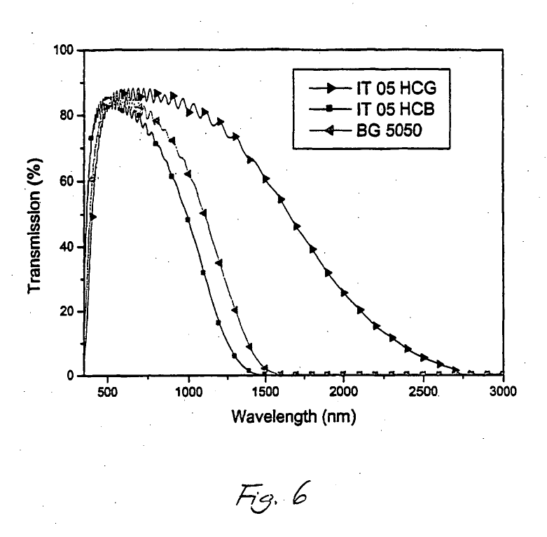

FIG. 6 transmission curves for coatings (layers), in which various procedures for manufacturing ITO have been used.

Indium tin oxide powder is manufactured in nanocrystalline form. A size analysis shows that the attained nano-powder has a maximum within the size spectrum of 100 nm and this maximum fell to almost 0% at 200 nm while under 1 nm no more ITO particles exist. Then, the conductivity of the ITO powder is determined, by pouring a 45 ml volume weighing glass with a diameter of 35 mm and a height of 70 mm half full of powder, setting a suitable press stamp on the loose powder and loading it with a weight of 1 kg for 30 seconds. The stamp was removed and pin-formed measurement electrodes with a diameter of 1.5 mm were pressed into the packed powder with 1 cm spacing and 0.7 cm deep. The electrical direct current resistance was determined between the electrodes. The selected powder shows good conductivity with 30-50 Ohms powder resistance.

The powder is used for the examples as follows:

### EXAMPLE 1

50 grams of a dispersion of the nanocrystalline ITO in n-butanol with a solids-content of 25 weight % was mixed with 25 grams of a 15 weight % polymer solution paraloid B 72 in ethylacetate. Glass was spray-coated with this coating solution and the resulting coating was dried at 70° C. The thickness of the layer is 1 μm. The layer is clearly transparent. A transmission curve is recorded. This is shown in FIG. 1a. The conductivity of the layer is determined to be 8×10⁴ Ω².

### EXAMPLE 2

50 grams of an ethanol dispersion of the nanocrystalline ITO powder with a solids-content of 25 weight % is mixed with 50 grams of a 15 weight % polymer solution paraloid B72 in ethylacetate. A glass plate was spin-coated with the coating solution. The glass was then dried. The layer thickness was 1 μm. The transmission curves can be taken from FIG. 2a. The conductivity of the layer is determined to be 10⁵ Ω².

### EXAMPLE 3

The lacquering system from example 2 was used and sprayed on PMMA plates. Again, the thickness was set to 1 μm and drying was done at 70° C. The transmission is shown in FIG. 3. The conductivity is determined to be 8×10⁴ Ω².

### EXAMPLE 4

50 grams of an Ethanol dispersion of the nanocrystalline ITO with a solids-content of 25 weight % is mixed with 32 grams of a 10 weight % polymer solution polyvinyl butyral (PVB) in isopropanol. This coating solution was spread over glass plates and dried at 50° C. The resulting layer is 3 μm thick and highly transparent. A transmission curve as shown in FIG. 5 was apparent. The conductivity of the layer is determined to be 8×10³ Ω².

The figures show that the transmission in the infrared range is greatly decreased in comparison with the uncoated substrates.

Conductivity measurements were taken on the attained layers. For example 2, conductivity was determined at 2×10⁵ Ω². For examples 1 and 3, the conductivity was 8×10⁴ Ω², for example 4 the conductivity was 8×10³ Ω². The comparison between examples 2 and 4 shows that the surface resistance depends on the binder. The amounts of nanocrystalline ITO in the layers showed that the concentration lie under the percolation limit.

In another example, the transmission of pure ITO of 1 μm, like spraying on a watery dispersion and finally heating to 500° and compared with a coating according to example 1. The coating corresponding with the invention shown in FIG. 5 shows a falling transmission with much shorter wave lengths therefore provides better infrared shielding.

Another example shows how the absorption edge can be moved:

Nanocrystalline In₂O₃/SnO₂ (ITO-) powder is produced from a watery solution using a coprecipitation process in which the soluble In— or Sn-components are precipitated with increased pH-value. In this example, the concentrations of these compounds are selected so that the Sn-concentration is 5% with reference to Observed; basically, the Sn concentration can be defined optionally.

This constant selection was chosen since it is known that various concentrations of Sn have a strong influence on the absorption behavior of ITO; in this example, the concentration of Sn is kept constant to shown that the absorption characteristics of an ITO material can be defined with certain compounding. After separating the reaction product, it is dried and tempered at 300° C. under normal atmospheric conditions 1 h to set up the crystalline phase.

The crystalline In₂O₃/SnO₂ is then split into two samples and the individual samples are re-tempered for different amounts of time under forming gas at 300° C. (see table 1).

Now, the respective powder (60 g) samples are each dispersed in 100 g isopropoxy ethanol (IPE) and the dispersions are each displaced with 39 g Nitrocellulose. Then, using a 50 μm coating scraper, layers are spread on the glass from the dispersions. The layer thickness after an hour of heating at 120° C. is 4 μm.

The color values and the transmission curves are then determined with the layers obtained with the powder. On both layers, the yellow value is measured with a color-pen (Dr. Lange) according to DIN 6167 and ASTM D 1925 (Standard illuminant C; Normal viewer 2°). Powder with color values lying between the maximum values listed in Table 1 (IT-05 HCB and IT-05-HCG) as well as layers having yellow values between the respective values from Table 1 can also be contained with mixtures of the various powders.

The corresponding x, y color values of the powder and the yellow values of the layers are listed in Table 1, transmission curves are found in FIG. 6.

TABLE 1

| Sample | Processing | Color value | |
|---|---|---|---|
| description | duration | (powder) | Yellow value (layer) |
| IT-05 HCB | 1.5 h | x = 0, 194, | 0.12 |
| | | y = 0, 332 | |
| BG9010 | 1 h | x = 0, 310, | 1.17 |
| | | y = O, 341 | |
| BG8515 | 50 min | x = 0, 306, | 2.97 |
| | | y = 0, 346 | |
| BG8020 | 45 min | x = 0, 310, | 4.63 |
| | | y = 0, 351 | |
| BG7030 | 40 min | x = 0, 318, | 6.4 |
| | | y = 0, 361 | |
| BG5050 | 30 min | x = 0, 338, | 12.66 |
| | | y = 0, 381 | |
| IT-05 HCG | — | x = 0, 414, | 23.8 |
| | | y = 0, 421 | |

A correlation was observed between the yellow value and absorption edge position. From this, it was recognized that ITO powder with a yellow value higher than 0.15, especially greater than 0.5 were well over the absorption edges in IR. This is to be favored in certain applications.

In another variation, the attained powder IT-05 HCG was displaced with 10% YKR-50/10 phtalocynanine color made by Yamamoto Chemicals. The layer that was made this way is especially suitable for applications in which complete IR shielding is desired.

1. Procedure for manufacturing a transparent IR shield, within which a carrier is provided with an active ingredient to be placed in the radiation path and characterized by a lacquer system with nanoparticulate particles and conventional lacquer solvent being applied onto a substrate in a wet process.

2. Procedure in accordance with claim 1, characterized by a lacquer system made by dispersing nanoparticulate particles.

3. Procedure in accordance with claim 1, characterized by a conventional lacquer solvent consisting of at least one of water, alcohol, butanol and/or other alcyl- or isoacyl alcohol, cetone, in particular acetone and/or MEK, dicetone, diole, carbitole, glycole, diglycole, triglycole, glycol ether, in particular ethoxy-, propoxy-, isoprpoxy-, butoxyethanol-acetate, ester, in particular glycolester, in particular ethyl acetate, butyl acetate, butoxyethyl acetate, alcane and/or a mixture containing alcane, aromate, in particular toluol xylol.

4. Procedure in accordance with claim 3, characterized in that a conventional lacquer solvent is used as a mixture of more than one of the listed substances.

5. Procedure in accordance with claim 1, characterized in that the lacquer system comprises a binding agent.

6. Procedure in accordance with claim 5, characterized in that the binding system has at least one organic component.

7. Procedure in accordance with claim 6, characterized in that the organic component provided is at least one of the polymer group polyacrylate, in particular PMMA, polyvinyl pyrrolidone (PVP), polyvinyl butyral (PVB), polyvinyl alcohol (PVA), polyetylene glycole, polyurethane, bisphenol based polymer, polyester, and oligomer and/or monomer of the aforementioned polymer and/or cellulose derivate, in particular methyl cellulose, hydroxypropyl cellulose and/or nitrocellulose and/or metal-organic compound.

8. Procedure in accordance with claim 5, characterized in that at least one silicone and/or silane in monomer, oligomer and/or polymer form belongs to the lacquer system.

9. Procedure in accordance with claim 1, characterized in that nanoparticles of size >1 nm are used.

10. Procedure in accordance with claim 9, characterized in that nanoparticles of a size >1 nm are exclusively used.

11. Procedure in accordance with claim 1,characterized in that nanoparticles of a size <200 nm are used.

12. Procedure in accordance with claim 1, characterized in that nanoparticles of a size <200 nm are used exclusively.

13. Procedure in accordance with claim 1, characterized in that a share >70%, in particular >90% of the nanoparticulate particles has a particle size under 100 nm.

14. Procedure in accordance with claim 1, characterized in that PVC (polyvinyl chloride), PE (polyethylene), PU (polyurethane), PC (polycarbonate), PET (polyethylene terephthalate), PMMA, PVB and/or a transparent polymer material and/or compound material and/or anorganic glass, in particular silicate glass such as flat-glass is used as the substrate.

15. Procedure in accordance with claim 1, characterized in that the wet application takes place by pressing, spindip-coating, spreading, immersing and/or spraying, in particular with an inkjet procedure.

16. Procedure in accordance with claim 15, whereby the wet application is performed using an inkjet procedure, characterized in that enabling, per se standard, rheology-changing substances are added to the lacquer system inkjet applications.

17. Procedure in accordance with claim 1, characterized in that a drying takes place at temperatures under 100° C. after the application.

18. Procedure in accordance with claim 17, characterized in that the drying takes place under 70° C.

19. Procedure in accordance with claim 1, characterized in that the drying takes place at over 50° C.

20. Procedure in accordance with claim 1, characterized in that the layer with at least antistatic characteristics is preferably made of a dissipative layer.

21. Procedure in accordance with claim 1, characterized in that the nanoparticulate particles are at least partially made of ITO.

22. Procedure in accordance with claim 1, characterized in that an ITO amount under the percolation limit is added.

23. Coating in accordance with claim 1, characterized in that this has an absorption edge within a range between 1100 nm and 1350 nm.

24. Coating in accordance with claim 1, characterized in that a second absorber is provided, in addition to an anorganic absorber with long-wave absorption, that absorbs within the range around and/or under 900 nm and in particular in near-infrared.

25. Coating in accordance with claim 24, characterized in that an organic absorber, in particular a phtalocyanine color and/or in particular in a weight less than 10% with reference to ITO, is provided as the other absorber.

26. Coating in accordance with claim 23, characterized in that an ITO with a yellow value of at least 0.15 and preferably at least 0.5 is used.

27. ITO powder with a yellow value of at least 0.5.
